(19) United States
(12) Patent Application Publication
(10) Pub. No.: US 2007/0167097 A1
(43) Pub. Date: Jul. 19, 2007

(54) Mold conditioning sheet and method of mold conditioning

(75) Inventors: Kiyohito Hiromitsu, Toyama (JP); Hiroaki Nomura, Toyama (JP)

Correspondence Address: YOUNG & THOMPSON, 745 SOUTH 23RD STREET, 2ND FLOOR, ARLINGTON, VA, 22202, US

(73) Assignee: Nippon Carbide Kogyo Kabushiki Kaisha, Tokyo (JP)

(21) Appl. No.: 10/590,243

(22) PCT Filed: May 19, 2005
(86) PCT No.: PCT/JP05/09124

§ 371 Date: Aug. 22, 2006

(30) Foreign Application Priority Data
May 28, 2004 (JP) 2004-158544
Jun. 22, 2004 (JP) 2004-183438
Jun. 22, 2004 (JP) 2004-183448
Feb. 23, 2005 (JP) 2005-046631

(51) Int. Cl. B29C 33/72; B29C 43/02

(52) U.S. Cl. 442/124; 264/39; 264/320; 442/59

(57) ABSTRACT

A mold conditioning sheet comprising at least two base sheets and a mold conditioning component (or a mold conditioning component and a molding member) enclosed between the base sheets. The base sheet as an upper side layer or an outermost layer is a fibrous base sheet having a porosity of 70% or more, and the base sheet as a lower side layer is a fibrous base sheet having a porosity of 40% or less and/or a heat-resistant film.

### TECHNICAL FIELD

The present invention relates to a mold conditioning sheet and a mold conditioning method for smooth release of molded parts from a mold die for thermosetting resin molding compounds. More particularly it relates to a mold conditioning sheet and a mold conditioning method for smooth release of molded parts from a mold die for single sided encapsulation of a substrate, such as a printed wiring board having chips built up thereon.

### BACKGROUND ART

In molding a thermosetting resin molding compound, such as an epoxy resin molding compound, a release agent contained in the thermosetting resin molding compound oozes out on the cavity surface of a mold die to display mold releasability. After running for a long period of time, the release agent and low molecular weight resin components of the thermosetting resin molding compound builds up on the cavity surface to cause noticeably poor mold release or molding defects such as plate-out, which can result in appearance of flow mark or loss of gloss.

This problem is settled by having the mold surface cleaned periodically. However, cleaning operation removes not only contaminants but a mold conditioning component. As a result, if manufacturing is resumed immediately after the cleaning operation, the molded products stick to the mold and are not released. Therefore, mold cleaning is usually followed by a few shots with a molding conditioning compound.

The same problem also occurs in cleaning the surfaces, etc. of a mold die for single-sided encapsulation, in which a printed wiring board having chips built up thereon (i.e., a printed circuit board) is set in a lower half by suction, and the upper side of the printed circuit board is sealed with a resin. That is, a product molded immediately after mold cleaning is not released from the mold die.

Thus, a mold of this type also needs a few shots with a mold conditioning compound after completion of cleaning operation. Because the lower half of such a mold for single-sided encapsulation has suction holes through which a printed circuit board, etc. is fixed by suction, a special jig having the same thickness as the board is set in the lower half by suction so that a cleaning compound or a conditioning compound may not enter the suction holes during cleaning or conditioning shots. However, mold cleaning and conditioning using such a jig has the following disadvantages. Setting the jig and removing the cured material together with the jig take too much time. A cleaning compound or a conditioning compound can leak from the suction holes, resulting in incomplete fill. Incomplete fill leads to low molding pressure and reduces the strength of a cured material, which can invite resin chipping.

To address the above problems, JP-A-9-70856 discloses a method for recovering mold releasability, in which a heat-resistant and flexible sheet having many fine pores at random and impregnated with a mold conditioning component is clamped between the mating surfaces of a mold.

However, the method is disadvantageous in that the sheet is capable of conditioning the parting surfaces of a mold but incapable of sufficiently conditioning the deep cavity surfaces because the sheet hardly reaches the cavity surfaces. Furthermore the conditioning component-impregnated sheet hardens on drying and easily breaks or dusts. When undried, the sheet is sticky, which impairs workability. The many, randomly formed fine pores reduce the sheet strength, which can result in a chipping problem. Where used to condition only the upper half of a mold, the many, randomly formed fine pores will cause the conditioning component to clog the suction holes of the lower half, which further deteriorates the workability.

### DISCLOSURE OF THE INVENTION

To overcome the above problems, the present inventors propose using a mold conditioning sheet composed of at least two base sheets and a mold conditioning component (or a mold conditioning component and a molding member) enclosed therebetween. The inventors have found that using a fibrous base sheet having a porosity of 70% or more as an outermost layer of the mold conditioning sheet improves workability (i.e., reduces the dusting or breaking problem) and allows the mold conditioning component to fill every detail of a mold.

The inventors have also found that using a fibrous base sheet having a porosity of 70% or more as an upper side layer or as an outermost layer of the mold conditioning sheet and using a fibrous base sheet having a porosity of 40% or less and/or a heat-resistant film as a lower side layer produces the following advantages. The suction holes of a lower half of a mold is protected from being clogged with a resin. The fibrous base sheet with a porosity of 70% or more used as an upper side layer or an outermost layer allows the mold conditioning component and a molding member to fill every detail of a mold.

The inventors have also found that, where a sealing member, such as film or tape, is used for enclosing the mold conditioning component, the sealing member functions as a stopper against resin leakage in carrying out mold conditioning. This excludes the necessity to set the molding conditioning sheet in an accurately right position in the cavity of a mold, whereby the workability problem can be settled. Besides, a cured resin of the mold conditioning sheet has enhanced strength because of the base sheets so that resin chipping is prevented from occurring on removal from the mold. The chipping problem is thus solved.

The present invention provides a mold conditioning sheet comprising at least two base sheets and a mold conditioning component enclosed therebetween. The mold conditioning sheet is characterized by having a structure in which the base sheets have a fibrous base sheet having a porosity of 70% or more as an outermost layer thereof.

The present invention also provides a mold conditioning sheet comprising at least two base sheets and a mold conditioning component enclosed therebetween. The mold conditioning sheet is characterized by having a structure in which the base sheets have a fibrous base sheet having a porosity of 70% or more as an upper side layer or an outermost layer thereof and a fibrous base sheet having a porosity of 40% or less and/or a heat-resistant film as a lower side layer thereof.

The present invention further provides a mold conditioning sheet comprising at least two fibrous base sheets, a mold conditioning component and a molding member, the mold conditioning component and the molding member being enclosed between the two fibrous base sheets, characterized in that the fibrous base sheets have a porosity of 70% or more and are each used as an outermost layer of the mold conditioning sheet.

The present invention also provides a method of conditioning a mold characterized by comprising the steps of inserting the above-described mold conditioning sheet according to the present invention in a heated mold, applying heat and pressure to the mold conditioning sheet for a predetermined time to cure the mold conditioning sheet, and removing the mold conditioning sheet from the mold.

According to the present invention, dusting, shape loss during transportation, and reduction of resin flowability are prevented. In carrying out mold conditioning by the method of the invention, the sealing member used to enclose the mold conditioning component, such as film or tape, serves as a stopper against resin leakage, which makes it easier to set the mold conditioning sheet in a mold. Resin chipping hardly occurs, which makes removal of a cured material from a mold easier and simpler. Thus, the present invention allows for extremely efficient mold conditioning with no workability problems. Use of a fibrous base sheet having a porosity of 70% or more as an outermost layer of the mold conditioning sheet allows the mold conditioning component to fill every part of a mold without sacrificing the strength of the base sheet.

According to the present invention, it is no more necessary to set a special jig having the same thickness as a substrate in a lower half of a mold so as to prevent a mold conditioning compound from entering suction holes for vacuum chucking. When the mold conditioning sheet which encloses therein a mold conditioning component and a molding member has a fibrous base sheet with a porosity of 70% or higher on its upper side or as an outermost layer and a fibrous base sheet having a porosity of 40% or less and/or a heat resistant film on its lower side, it is easily set between mold halves and does not cause the mold conditioning resin to clog the suction holes of the lower half of the mold. The fibrous base sheet having a porosity of 70% or more on the upper side allows the mold conditioning component to pass through and fill every detail of the mold. The fibrous base sheet serves as a reinforcing filler to enhance the peel strength of a cured sheet and markedly reduces occurrence of resin chipping.

### BRIEF DESCRIPTION OF THE DRAWINGS

FIG. 1 is a cross-section and a plan of mold conditioning sheet A of Example 1.

FIG. 2 is a cross-section and a plan of mold conditioning sheet B of Example 2.

FIG. 3 is a cross-section and a plan of mold conditioning sheet E of Example 4.

FIG. 4 is a cross-section and a plan of mold conditioning sheet F of Example 5.

FIG. 5 is a cross-section and a plan of mold conditioning sheet G of Example 6.

FIG. 6 is a cross-section and a plan of mold conditioning sheet H of Example 7.

FIG. 7 is a cross-section and a plan of mold cleaning sheet S of Preparation Example 5.

FIG. 8 is a cross-section and a plan of mold conditioning sheet I of Example 8.

FIG. 9 is a cross-section and a plan of mold conditioning sheet J of Example 9.

FIG. 10 is a cross-section and a plan of mold conditioning sheet K of Example 10.

FIG. 11 is a cross-section and a plan of mold conditioning sheet L of Example 11.

FIG. 12 is a cross-section and a plan of mold conditioning sheet M of Example 12.

### THE BEST MODE FOR CARRYING OUT THE INVENTION

The fibrous sheets that can be used in the invention include paper, woven fabric, and nonwoven fabric, each having heat resistance of 100° C. or higher. Taking ease of waste disposal, such as incineration, into consideration, fibrous base sheets made of paper, cotton woven fabric, etc. are preferred. Meshes made of yarns are also preferably used.

Examples of the base sheets include Bemlieseâ PO500, BA832, 832R, BA112, 112R, RB119, 142, 149, and 839 (available from Asahi Kasei Fibers Corp.); Eculeâ 6301A, 6401A, 6501A, 6601A, 6701A, and 6A01A and Volansâ 4050P, 4061P, 4080P, 4081P, 4091P, 7093P, and 7121P (available from Toyobo Co., Ltd.); Miracle Clothâ DF-1-73 and DF-5-100 and Apitasâ RPN5-60SA and LS-70 (available from Daiwabo Co., Ltd.); Marixâ 10606WTD, 70500WSO, 90403WSO, 20451FLV, 20707WTA, and 70600WTO, Nyaceâ P0703WTO, and WiWiâ R0405WTO and R0705WTO (available from Unitika, Ltd.); Kinoclothâ KS40, K60, and K70 and Palelothâ P40 and P60 (available from Oji Kinocloth Co., Ltd.); Panelonâ 2610, 270, 6810, K550, 5130, S30off, 3700, RF860, 7330GP, 5140, 5150, 5160, FT500, FT800, TO510, and IH250 (available from Dynic Corp.); Oikosâ AP2050, AP2060, AP2080, AP2120, AM2060, AK2045, TDP2050, and TDP2060 (available from Nisshinbo Industries, Inc.); and 4000CR, PS-750CR, 8890CR, WE-60CR, H-8010E, JH-3003N, HP21, and HP55 (available from Japan Vilene Co., Ltd.).

Examples of the fibrous base sheets with a porosity of 70% or more are Bemlieseâ PO500, BA832, 832R, BA112, 112R, RB119, 142, 149, and 839 (from Asahi Kasei Fibers Corp.); Eculeâ 6301A, 6401A, 6501A, 6601A, 6701A, and 6A01A and Volansâ 4050P, 4061P, 4080P, 4081P, 4091P, 7093P, and 7121P (from Toyobo Co., Ltd.); Panelonâ 2610, 270, 6810, K550, 5130, S30off, 3700, RF860, TO510, and IH250 (from Dynic Corp.); Oikosâ AP2050, AP2060, AP2080, AM2060, AK2045, TDP2050, and TDP2060 (from Nisshinbo Industries, Inc.); and HP21 and HP55 (from Japan Vilene Co., Ltd.).

These fibrous base sheets are capable of allowing the mold conditioning component and the molding member to fill throughout the mold without requiring a number of holes made therethrough. Having no holes, they have strength not to tear or break when removed after conditioning.

These base sheets with a porosity of 70% or more can be used either alone or as a combination thereof. For instance, a set of two thin sheets or a set of a pair of thin sheets and a thick sheet sandwiched therebetween can be used. A base sheet having a porosity of less than 70% may be disposed inside.

The fibrous sheet with a porosity of 40% or less that is used on the lower side of the conditioning sheet can easily be obtained by compressing existing nonwoven fabric having a porosity higher than 40% (e.g., the above described fibrous sheet with a porosity of 70% or higher) on a press, etc.

The heat resistant film that can be used on the lower side of the conditioning sheet is suitably a resin film having heat resistance of 150° C. or higher, preferably 200° C. or higher.

A laminate sheet composed of the fibrous base sheet and the heat resistant film is also useful as a lower base sheet. Since the fibrous base sheet with a porosity of 40% or less easily loses its thickness on being compressed, a stack of a plurality of the fibrous base sheets may be used on the lower side.

Although the size of the base sheets is not particularly limited, it is advisable to use base sheets slightly larger than the mold area in case the resin leaks from air vents, etc. during conditioning. Even if the resin leaks, it would be absorbed by the margin of the base sheets, and the time required for clearing the leaked resin can be reduced.

The size of the margin is not generally specified because the resin's penetrability into the base sheet varies depending on the base sheet/resin combination. Nevertheless a recommended margin is about 5 cm or wider from the edge of the mold, taking the workability after conditioning operation into consideration.

The conditioning component has at least one form selected from a tablet form, a granular form, a powder form, a sheet form, and a plate form. The conditioning component may be enclosed in between two cut base sheets or in a bag made by folding a single sheet at least twice as large as the mold area into two.

At least one sealing member selected from a thermoplastic resin film, a thermoplastic resin tape, a double sided tape, an adhesive, a pressure-sensitive adhesive, etc. may be applied to a prescribed part of one or more of the base sheets.

The thermoplastic resin film or tape can be applied to the base sheet by any method. For example, the base sheet is laminated with a thermoplastic resin film, or a thermoplastic resin tape of given width is stuck to the base sheet, or the base sheet is laminated with a thermoplastic resin film whose central portion of moderate size has been cut out.

The base sheets may be adhered together by pressing or deforming without using any sealing member.

The method of enclosing a conditioning component is not particularly limited. For example, a thermoplastic resin film is applied to a prescribed part of a lower base sheet, and a given weight of a conditioning component having at least one of a tablet form, a granular form, a powder form, a sheet form, and a plate form is put on the lower base sheet in the part not covered with the thermoplastic resin film. Another base sheet (upper base sheet) having the same shape as the lower one is superposed thereon. The superposed base sheets are heat sealed together taking care not to move the conditioning component disposed therebetween.

It is preferred that the part where the conditioning component is to be placed be divided into sections having a moderate area so that the conditioning component may not move during transportation.

A base sheet with a double sided adhesive tape, an adhesive, a pressure-sensitive adhesive, etc. applied to a prescribed part thereof over a moderate area may also be used to enclose the conditioning component.

Where the conditioning component is sealed (enclosed) by adhering the base sheets either with a double sided tape, an adhesive, a pressure-sensitive adhesive, etc. or by heat sealing via a thermoplastic resin film or tape, it is preferred to apply the sealing member around the conditioning component as well as to the edges of the base sheets, whereby the conditioning component is double sealed. Should the inner sealing member melt to allow the conditioning component to flow out, it will be held back by the outer sealing member and thereby prevented from leaking.

The mold conditioning member (mold conditioning component) used in the invention contains a thermosetting resin, such as a melamine resin, an epoxy resin or a phenol resin, as a main component. A melamine resin is particularly useful for its curing properties.

A melamine resin is a resin obtained by methylolating a triazine, e.g., melamine, with formaldehyde, etc. A melamine-formaldehyde resin is usually used.

A melamine-formaldehyde resin is generally produced in the form of an aqueous solution. A powdered form is obtained by drying the aqueous solution by, for example, spray drying. A granular form is obtained by blending the aqueous solution with pulp followed by drying. A tablet form is obtained by punching the powdered or granular form.

A sheet form is obtained by impregnating a base of sheet form with the melamine-formaldehyde resin aqueous solution followed by drying. A plate form is obtained by tableting the powdered or granular form in a tableting machine.

The impregnation is carried out by dipping a base in the melamine-formaldehyde resin aqueous solution and drying the impregnated base to give a resin of sheet form. The impregnation ratio of the resin into the base can be adjusted as desired by, for example, altering the kind of the base, adjusting the resin solution concentration, or controlling the degree of squeezing off the resin solution. The impregnation ratio is also adjustable by controlling the curability or flowability of the resin.

The mold conditioning member contains a mold release agent in addition to the thermosetting resin.

Examples of the mold release agent include long-chain fatty acids, such as stearic acid and behenic acid, long-chain fatty acid metal salts typified by zinc stearate and calcium stearate, ester waxes exemplified by camauba wax, montane wax, and partially saponified montanic ester wax, long-chain fatty acid amides, such as stearylethylenediamide, and paraffin, such as polyethylene wax.

The release agent is used in an amount of about 0.5 to 20 parts by weight, preferably about 1 to 5 parts by weight, per 100 parts by weight of the thermosetting resin. Although the compounding ratio is not particularly limited to the recited range, the mold conditioning operations will have to be repeated an increased number of times to recover mold releasability if the amount of the release agent is too small. If the release agent is added too much, an increased number of dummy shots with a molding compound will be needed after the mold conditioning process to remove the cause of poor appearance of molded products.

The mold conditioning member is obtained by blending the thermosetting resin, the release agent, and, if necessary, other additives (such as a lubricant, mineral powder, and a curing catalyst) and uniformly mixing the blend by means of a kneader, a ribbon blender, a Henschel mixer, a ball mill, etc. The resulting mold conditioning member can be punched to easily provide a mold conditioning member of tablet or plate form. A powdered, granular or sheet-shaped mold conditioning member is also prepared by adding a release agent to the melamine resin aqueous solution.

The mold conditioning member of sheet or plate form can be cut to shape, including squares, rectangles, strips, and other shapes, on use. A cut piece which has a high impregnation ratio can be used alone or as combined with another one or two. Several cut pieces which have a low impregnation ratio can be used as stacked one on top of another.

The mold conditioning sheet having the mold conditioning member enclosed therein can be made to the shape of a mold, or a plurality of the mold conditioning members can be disposed so as to efficiently fill the cavity and the pot with the resin.

Use of the mold conditioning member makes it feasible to dispose the resin uniformly in a mold and to prevent incomplete fill.

The conditioning sheet of the present invention can contain a molding member selected from unvulcanized synthetic rubber and unvulcanized natural rubber in addition to the mold conditioning member.

The synthetic rubber includes, but is not limited to, butyl rubber, acrylic rubber, silicone rubber, polybutadiene, polyisoprene, a styrene-butadiene copolymer, a styrene-isoprene copolymer, an acrylonitrile-butadiene copolymer, an ethylene-α-olefin copolymer, an ethylene-α-olefin-polyene copolymer, a styrene-butadiene-styrene block copolymer, a styrene-isoprene-styrene block copolymer, a hydrogenated styrene-ethylene-butylene-styrene block copolymer, and an ethylene-based ionomer.

The unvulcanized synthetic or natural rubber exhibits moderate viscoelasticity when heat melted. It is a member having an important function of moving the upper and the lower base sheets toward the upper and the lower sides of a mold when the mold is clamped. This function brings the base sheets close to the cavity surface thereby reducing chipping that tends to occur in the comers or the air vent of the cavity. The function also improves filling of the cavity with the resin thereby eliminating such defects as incomplete fill resulting from insufficient flowability of the mold conditioning member or insufficient pressure during conditioning.

After molding, because the base sheets used in the present invention are embedded in a molded product, the base sheets have the same effect as a filler enhancing the strength of a molded product. Typically, pulp has been used to increase the molded product strength. Replacement of pulp with the base sheets brings about increased bonding strength between a filler and a molded product, leading to increased strength of the molded product. Resin permeability can be secured by using a fibrous base sheet with a porosity of 70% or more as an upper side layer or an outermost layer. A combined use of the base sheets with a filler further improves the molded product strength. The improved molded product strength provides a resolution to the chipping problem. As a result, workability as well as mold releasability are improved.

### EXAMPLES

The present invention will now be illustrated in greater detail with reference to Examples, but it should be understood that the invention is not limited thereto.

### Reference Example 1

A melamine-formaldehyde resin was synthesized by a heat reaction between 480 parts of melamine and 522 parts of formalin (37% aqueous solution) in a known manner. The resulting resin solution was kneaded with 248 parts of pulp, and the mixture was dried under reduced pressure to obtain a pulp-loaded melamine-formaldehyde resin, which was roughly ground in a shear grinder to prepare melamine-formaldehyde resin granules.

### Preparation Example 1

Sixty parts of the pulp-loaded melamine-formaldehyde resin granules obtained in Reference Example 1, 40 parts of a commercially available melamine resin (Nikaresin S-176, available from Nippon Carbide Industries, Co., Inc.), 0.5 parts of benzoic acid, and 1.5 parts of zinc stearate were mixed and ground in a ball mill to prepare a mold conditioning resin compound. The resulting compound was compressed on a tableting machine to prepare plate-shaped conditioning member X of 150 mm in width, 200 mm in length, and 3 mm in thickness.

### Preparation Example 2

The plate-shaped conditioning member X obtained in Preparation Example 1 was ground in a crusher and sieved to remove fine particles to prepare granular conditioning member Y.

### Preparation Example 3

Sixty parts of the melamine-formaldehyde resin granules obtained in Reference Example 1, 40 parts of a commercially available melamine resin (Nikaresin S-176, available from Nippon Carbide Industries Co., Inc.), 0.5 parts of benzoic acid, 1.2 parts of zinc stearate, and 0.3 parts of carnauba wax were mixed and ground in a ball mill to prepare mold conditioning resin compound. The resulting compound was tableted on a tableting machine to prepare plate-shaped mold conditioning member Z of 200 mm in length, 100 mm in width, and 3 mm in thickness.

### Preparation Example 4

A hundred parts of an ethylene-propylene-diene rubber having a Mooney viscosity of 15 and 10 parts of oil mainly comprising petroleum hydrocarbons were kneaded in a pressure kneader for 10 minutes. The resulting mass was extruded from a twin-screw extruder into sheeting, which was rolled to prepare sheet molding member R having a width of 150 mm and a thickness of 3 mm.

### Preparation Example 5

Sixty parts of the melamine-formaldehyde resin granules obtained in Reference Example 1, 40 parts of a commercially available melamine resin (Nikaresin S-176, available from Nippon Carbide Industries Co., Inc.), 0.5 parts of benzoic acid, and 0.5 parts of zinc stearate were mixed and ground in a ball mill to prepare a mold cleaning resin compound.

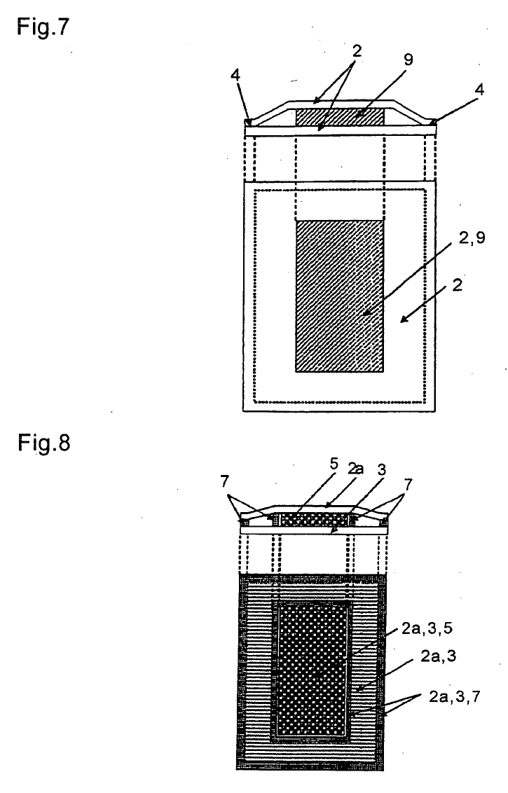

The resulting cleaning compound was tableted on a tableting machine to prepare plate-shaped mold cleaning member of 200 mm in length, 100 mm in width, and 3 mm in thickness. The mold cleaning member was placed on the center of a 200 mm wide and 300 mm long fibrous base sheet of HP21 (available from Japan Vilene Co., Ltd.; porosity: 94%). Another base sheet of HP21 of the same size was superposed thereon to have the plate-shaped cleaning member sandwiched therebetween, followed by pressing for fixation. The side edges of the two base sheets were heat sealed to obtain mold cleaning sheet S shown in FIG. 7.

### Example 1

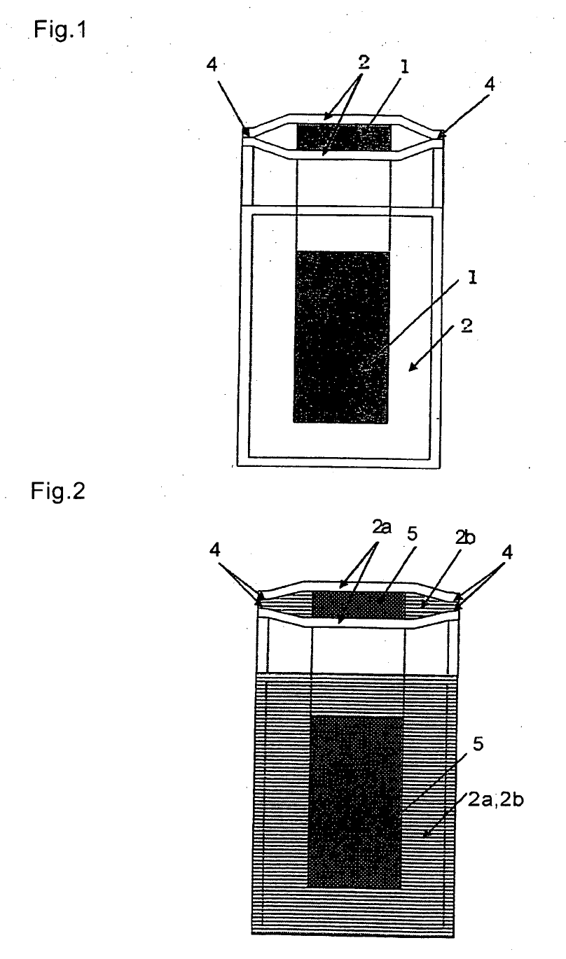

Plate-shaped mold conditioning member X obtained in Preparation Example 1 was placed on the center of a 200 mm wide and 300 mm long fibrous base sheet of HP21 (available from Japan Vilene Co., Ltd.; porosity: 94%). Another base sheet of HP21 of the same size was superposed thereon to have the plate-shaped conditioning member X sandwiched therebetween, followed by pressing to fix the mold conditioning member X. The side edges of the two base sheets were heat sealed to obtain mold conditioning sheet A shown in FIG. 1.

The results of a mold conditioning test using mold conditioning sheet A are shown in Table 1 below. As can be seen from the test results, the mold conditioning sheet A showed satisfactory moldability and mold releasability.

### Example 2

A 200 mm wide and 300 mm long sheet of T0510 (available from Dynic Corp.; porosity: 99%) was cut along a rectangle each side of which was 25 mm inward from each side edge of the sheet to prepare a frame. The frame was placed on a 200 mm wide and 300 mm long sheet of Bemliese BA112 (available from Asahi Kasei Fibers; porosity: 85%). The granular conditioning member Y prepared in Preparation Example 2 was put inside of the frame, and another Bemliese of the same size was superposed thereon. The side edges of the laminate were heat sealed to obtain mold conditioning sheet B shown in FIG. 2.

The results of a mold conditioning test using mold conditioning sheet B are shown in Table 1. As can be seen from the test results, the mold conditioning sheet B exhibited satisfactory moldability and mold releasability.

### Example 3

Mold conditioning sheet C was prepared in the same manner as in Example 1, except for replacing plate-shaped mold conditioning member X with plate-shaped mold conditioning member Z obtained in Preparation Example 3.

The results of a mold conditioning test using mold conditioning sheet C are shown in Table 1. As can be seen from the test results, the mold conditioning sheet C exhibited satisfactory moldability and mold releasability.

### Comparative Example 1

Mold conditioning sheet D was prepared in the same manner as in Example 1, except for using H-8010E (available from Japan Vilene Co., Ltd.; porosity: 63%) in place of HP21 (available from Japan Vilene Co., Ltd.; porosity: 94%).

The results of a mold conditioning test using mold conditioning sheet D are shown in Table 1.

A mold conditioning test was carried out using mold conditioning sheets A to D and a commercially available tablet-form mold conditioning material EMEC-100 (available from Sumitomo Bakelite Co., Ltd.) in accordance with the following test method. The results obtained are shown in Table 1.

Test Method:

Five hundred shots of a commercially available biphenyl epoxy resin molding compound (CEL-9200XU, available from Hitachi Chemical Co., Ltd.) were made in a 12-cavity mold for TQFP packaging to create mold stains. The stained mold was cleaned by giving 5 shots with mold cleaning sheet S obtained in Preparation Example 5. After the cleaning process, a mold conditioning test was conducted using each of mold cleaning sheets A to D and commercially available mold conditioning tablets EMEC-100.

The capability of filling the cavity with the resin (resin filling) were evaluated by the percentage of upper and lower cavity halves that were completely filled with the resin to the total 24 halves of the 12 cavities.

The anti-chipping properties were evaluated by the number of chippings in the cavities.

TABLE 1

| | | Example | | | Comp. Example | |
|---|---|---|---|---|---|---|
| | | 1 | 2 | 3 | 1 | 2 |
| Conditioning Sheet | | A | B | C | D | EMEC-100 |
| Porosity of Base Sheets (%) | | 94/94 | 85/99/85 | 94/94 | 63/63 | — |
| Mold Temperature (° C.) | | 175 | 175 | 175 | 175 | 175 |
| Setting | Conditioning Sheet | 2 | 2 | 2 | 2 | 10 |
| Time (sec) | Dummy Frame | — | — | — | — | 10 |

| | | | | | |
|---|---|---|---|---|---|
| Curing Time (sec) | 180 | 180 | 180 | 180 | 180 |
| Removal Time (sec) | 5 | 5 | 5 | 20 | 50 |
| Number of Shots | 2 | 2 | 2 | 2 | 2 |
| Total Time for Conditioning (sec) | 374 | 374 | 374 | 404 | 500 |
| Resin Filling (%) | 100 | 100 | 100 | 92 | 100 |
| Number of Chippings | 0 | 0 | 0 | 3 | 8 |

### Example 4

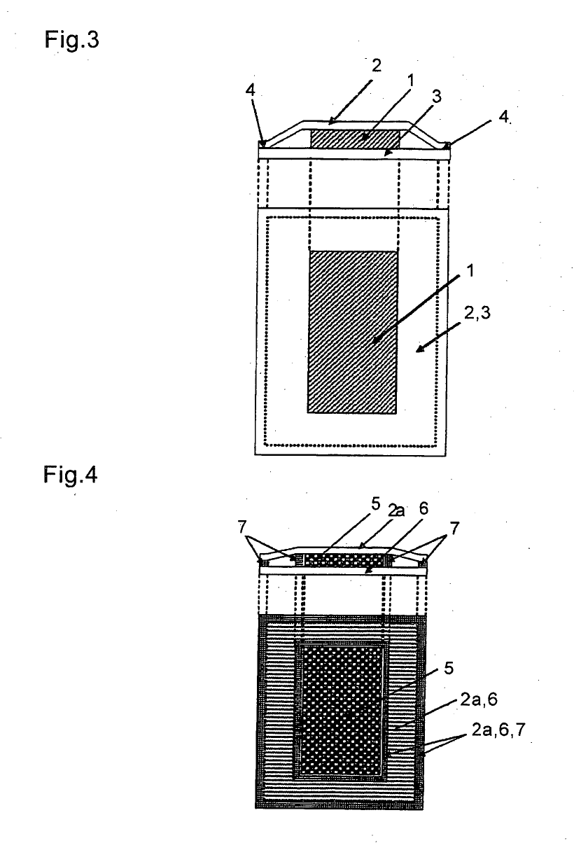

Plate-shaped mold conditioning member X obtained in Preparation Example 1 was placed on the center of a 200 mm wide, 300 mm long, and 100 μm thick film of polyethylene terephthalate, and a 200 mm wide and 300 mm long fibrous base sheet of HP21 (available from Japan Vilene Co., Ltd.; porosity: 94%) was superposed thereon to have the plate-shaped conditioning member X sandwiched therebetween, followed by pressing at 80° C. to fix the mold conditioning member X. The side edges were heat sealed to obtain mold conditioning sheet E shown in FIG. 3.

The results of a mold conditioning test using mold conditioning sheet E are shown in Table 2 below. As can be seen from the test results, the mold conditioning sheet E exhibited satisfactory mold conditioning effects.

### Example 5

A nonwoven cotton fabric (Bemliese BA112, from Asahi Kasei Fibers Corp.) was compressed to reduce the porosity to 40% or less. The compressed Bemliese BA112 was cut to a width of 200 mm and a length of 300 mm, and two cut sheets were stacked. Intact Bemliese BA112 (porosity: 85%) cut to the same size was placed thereon. The three sheets were joined by hot melting a thermoplastic resin tape applied along the position 25 mm inward from each of the three edges (heat sealing). The section defined by the compressed Bemliese BA112, the intact Bemlise BA112, and the heat seal was filled with the granular conditioning member Y prepared in Preparation Example 2 and heat sealed along the position 25 mm inward from the remaining open edge in the same manner as described above thereby to enclose the granules. The four edges of the three sheets were then heat sealed via a thermoplastic resin tape to obtain mold conditioning sheet F shown in FIG. 4.

The results of a mold conditioning test using mold conditioning sheet F are shown in Table 2 below. As can be seen from the test results, the mold conditioning sheet F exhibited satisfactory mold conditioning effects.

### Example 6

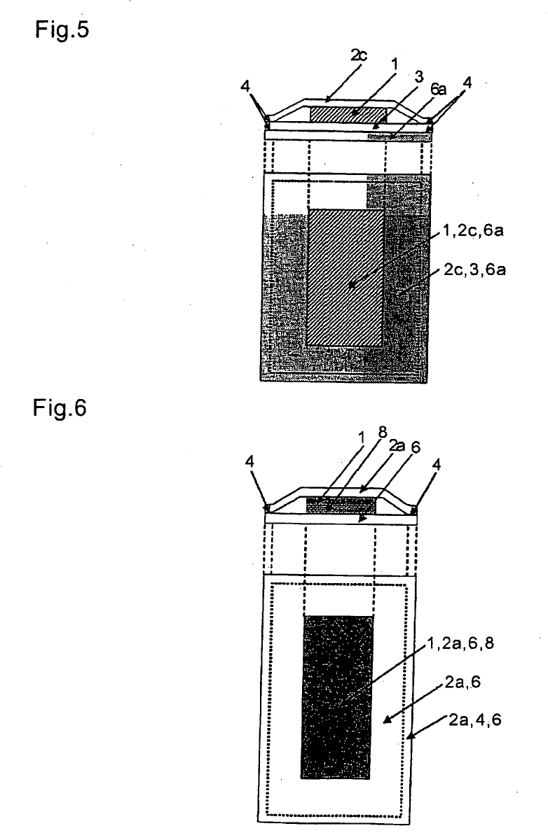

A nonwoven fabric (Volans 4091P, from Toyobo Co., Ltd.) was compressed to reduce the porosity to 40% or less and cut to width of 200 mm and a length of 300 mm. A 75 μm thick PET film of the same size was superposed thereon. The plate-shaped conditioning member X obtained in Preparation Example 1 was put on the center of the PET film. A cut sheet of intact Volans 4091P (porosity: 94%) of the same size was superposed thereon to sandwich the conditioning member X. The laminate was pressed at 80° C. to fix the conditioning member X onto the PET film. The four side edges of the laminate were heat sealed to obtain mold conditioning sheet G shown in FIG. 5.

The results of a mold conditioning test using mold conditioning sheet G are shown in Table 2 below. As can be seen from the test results, the mold conditioning sheet G exhibited satisfactory mold conditioning effects.

### Example 7

A nonwoven fabric (Bemliese BA112, from Asahi Kasei Fibers Corp.) was compressed to reduce the porosity to 40% or less. The compressed Bemliese BA112 was cut to a width of 200 mm and a length of 300 mm. The sheet molding member R prepared in Preparation Example 4 was put on the center of the sheet. The plate-shaped conditioning member X obtained in Preparation Example 1 was superposed on the molding member R. Intact Bemliese BA112 (porosity: 85%) cut to the same size as the lower Bemliese sheet was placed thereon, and the stack was pressed at 80° C. to fix the sheets and the members. The four edges of the upper and lower sheets were heat sealed to obtain mold conditioning sheet H shown in FIG. 6.

The results of a mold conditioning test using mold conditioning sheet H are shown in Table 2 below. As can be seen from the test results, the mold conditioning sheet H exhibited satisfactory mold conditioning effects.

### Example 8

On a 200 mm wide, 300 mm long, and 100 μm thick film of polyethylene terephthalate was superposed Bemliese BA112 (available from Asahi Kasei Fibers; porosity: 85%) of the same size, and the two sheets were joined by heat sealing via a thermoplastic film applied along the position 25 mm inward from each of the three edges to make a bag. The bag was filled with granular mold conditioning member Y prepared in Preparation Example 2. The opening of the bag was closed by heat sealing via a thermoplastic film applied along the position 25 mm inward from the open edge thereby enclosing the granular mold conditioning member Y. Finally, the four edges were similarly heat sealed via a thermoplastic film to obtain mold conditioning sheet I shown in FIG. 8.

The results of a mold conditioning test using mold conditioning sheet I are shown in Table 2 below. As can be seen from the test results, the mold conditioning sheet I exhibited satisfactory mold conditioning effects.

### Example 9

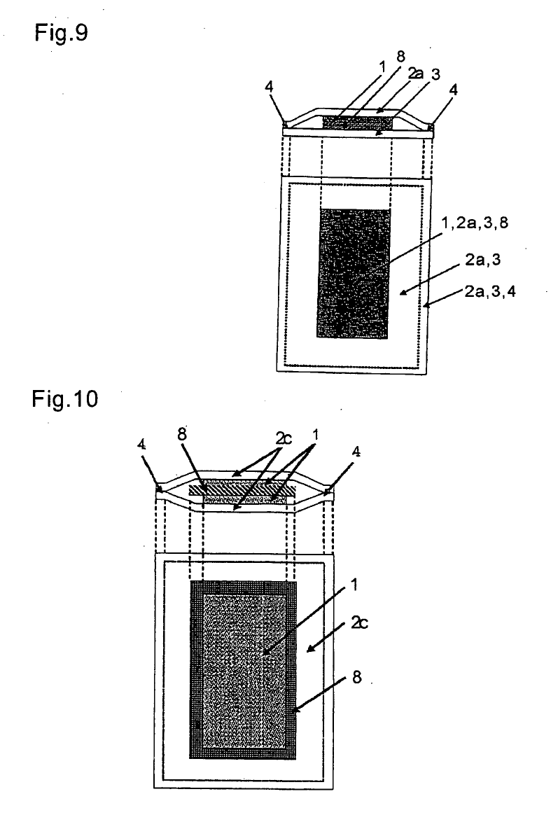

Molding member R of sheet form obtained in Preparation Example 4 was placed on the center of a 200 mm wide, 300 mm long, and 100 μm thick film of polyethylene terephthalate. Plate-shaped mold conditioning member X obtained in Preparation Example 1 was put on the molding member R. Bemliese BA112 (available from Asahi Kasei Fibers; porosity: 85%) of the same size as the lower side base was superposed thereon, and all the members were fixed by pressing at 80° C. The side edges were heat sealed to obtain mold conditioning sheet J shown in FIG. 9.

The results of a mold conditioning test using mold conditioning sheet J are shown in Table 2 below. As can be seen from the test results, the mold conditioning sheet J exhibited satisfactory mold conditioning effects.

A mold conditioning test was carried out using mold conditioning sheets E to J in accordance with the following test method. The results obtained are shown in Table 2.

Test Method:

Five hundred shots of a commercially available biphenyl epoxy resin molding compound (CEL-9200XU, available from Hitachi Chemical Co., Ltd.) were made in a mold die for QFN packaging to create mold stains. The stained mold was cleaned by giving 5 shots with mold cleaning sheet S obtained in Preparation Example 5. After the cleaning process, a mold conditioning test was conducted using each of mold cleaning sheets E to J.

The mold conditioning sheets were evaluated in terms of an average time required for removing the molded product. The capability of filling the cavity with the resin (resin filling) was evaluated by the percentage of the cavities that were completely filled with the resin to the total cavities.

The anti-chipping properties were evaluated by the number of chippings in the cavities.

TABLE 2

| | Example | | | | | |
|---|---|---|---|---|---|---|
| | 4 | 5 | 6 | 7 | 8 | 9 |
| Conditioning Sheet | E | F | G | H | I | J |
| Porosity of Base Sheets | 94/0 | 85/33 | 94/0/38 | 85/33 | 85/0 | 85/0 |
| (%) | | | | | | |
| Heat-Resistant Film | yes | no | yes | no | yes | yes |
| Mold Temperature (° C.) | 175 | 175 | 175 | 175 | 175 | 175 |
| Curing Time (sec) | 180 | 180 | 180 | 180 | 180 | 180 |
| Average Removal Time | 5 | 5 | 5 | 5 | 5 | 5 |
| (sec/sheet) | | | | | | |
| Resin Filling (%) | 100 | 100 | 100 | 100 | 100 | 100 |
| Number of Chippings | 0 | 0 | 0 | 0 | 0 | 0 |

### Example 10

Plate-shaped mold conditioning member X obtained in Preparation Example 1 was placed on the center of a 200 mm wide, 300 mm long fibrous base sheet of Volans 4091P (available from Toyobo Co., Ltd.; porosity: 94%). Molding member R of sheet form obtained in Preparation Example 4 cut to a length of 250 mm was put on the center of the base sheet. Plate-shaped mold conditioning member X obtained in Preparation Example 1 was put on the molding member R. Finally, Volans 4091P of the same size as used above was superposed thereon to have the molding member R of sheet form and the plate-shaped conditioning members X sandwiched between the two sheets of Volans 4091P, followed by pressing to fix them. The side edges were heat sealed to obtain mold conditioning sheet K shown in FIG. 10.

The results of a mold conditioning test using mold conditioning sheet K are shown in Table 3 below. As can be seen from the test results, the mold conditioning sheet K exhibited satisfactory moldability and mold releasability.

### Example 11

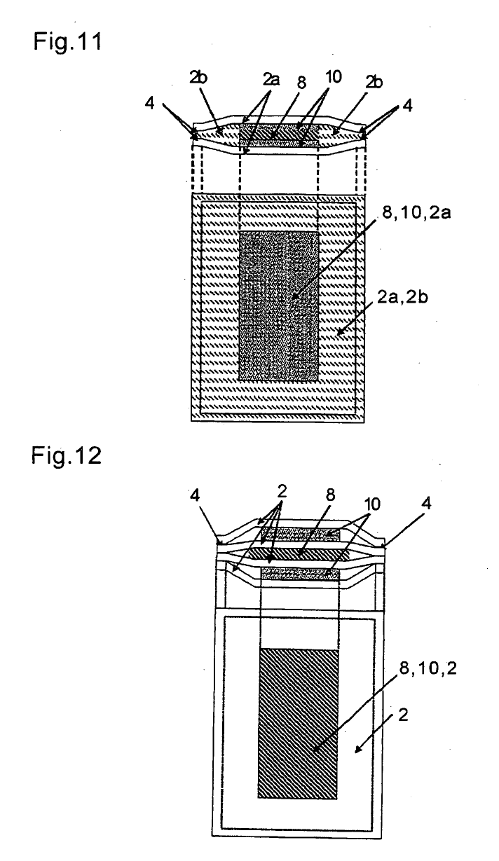

A 200 mm wide and 300 mm long sheet of T0510 (available from Dynic Corp.; porosity: 99%) was cut along a rectangle each side of which was 25 mm inward from each side edge of the sheet to prepare a frame. The frame was placed on a 200 mm wide and 300 mm long cut sheet of Bemliese BA112 (available from Asahi Kasei Fibers; porosity: 85%). Plate-shaped mold conditioning member Z prepared in Preparation Example 3 was put inside of the frame. Molding member R of sheet form obtained in Preparation Example 4 was placed thereon, and another plate-shaped mold conditioning member Z obtained in Preparation Example 3 was put on the molding member R. Finally, another Bemliese BA112 sheet of the same size was superposed thereon. The side edges of the laminate were heat sealed to obtain mold conditioning sheet L shown in FIG. 11.

The results of a mold conditioning test using mold conditioning sheet L are shown in Table 3. As can be seen from the test results, the mold conditioning sheet L exhibited satisfactory moldability and mold releasability.

### Example 12

Plate-shaped mold conditioning member Z obtained in Preparation Example 3 was placed on the center of a 200 mm wide and 300 mm long fibrous base sheet of HP21 (available from Japan Vilene Co., Ltd.; porosity: 94%). Another fibrous base sheet of HP21 of the same size was superposed thereon to have the plate-shaped conditioning member Z sandwiched therebetween, followed by pressing to fix the mold conditioning member Z, to prepare mold conditioning sheet M1. In the same manner mold conditioning sheet M2 having the same size was prepared. Mold conditioning members M1 and M2 were stacked with molding member R of sheet form obtained in Preparation Example 4 sandwiched therebetween in the center, and the three members were pressed and fixed together. The side edges were heat sealed to obtain mold conditioning sheet M shown in FIG. 12.

The results of a mold conditioning test using mold conditioning sheet M are shown in Table 3. As can be seen from the test results, the mold conditioning sheet M showed satisfactory moldability and mold releasability.

A mold conditioning test was carried out using mold conditioning sheets K to M in the same manner as for the mold conditioning sheets A to D. The results obtained are shown in Table 3.

TABLE 3

| | | Example | | |
|---|---|---|---|---|
| | | 10 | 11 | 12 |
| Conditioning Sheet | | K | L | M |
| Porosity of Base Sheets (%) | | 94/94 | 85/99/85 | 94/94/94/94 |
| Mold Temperature (° C.) | | 175 | 175 | 175 |
| Setting | Conditioning Sheet | 2 | 2 | 2 |
| Time (sec) | Dummy Frame | — | — | — |

| | | | |
|---|---|---|---|
| Curing Time (sec) | 180 | 180 | 180 |
| Removal Time (sec) | 5 | 5 | 5 |
| Number of Shots | 2 | 2 | 2 |
| Total Time for Conditioning (sec) | 374 | 374 | 374 |
| Resin Filling (%) | 100 | 100 | 100 |
| Number of Chippings | 0 | 0 | 0 |

In FIGS. 1 through 12, the numeral 1 indicates plate-shaped mold conditioning member X; 2, 2a, 2b and 2c, a base sheet having a porosity of 70% or more; 3, a heat resistant film; 4, a heat seal; 5, granular mold conditioning member Y; 6 and 6a, a base sheet having a porosity of 40% or less; 7, a thermoplastic film; 8, sheet-shaped molding member R; 9, plate-shaped cleaning member S; and 10, plate-shaped mold conditioning member Z.

### INDUSTRIAL APPLICABILITY

By use of the mold conditioning sheet of the present invention, a mold die for single-sided encapsulation having suction holes in the lower half can easily and efficiently recover releasability because it is no more necessary to pre-set an expensive printed circuit board or a dummy jig. Since the resin is prevented from entering the suction holes, incomplete cavity fill due to resin leakage does not occur, and a molded product is easily removed from the mold. The fibrous base sheet having a porosity of 70% or more used on the upper side of the mold conditioning sheet allows the conditioning member to fill every part of the mold while retaining the strength as a base sheet. For all these reasons, the molding conditioning sheet of the present invention exhibits excellent mold conditioning performance and workability.

1-12. (canceled)

13. A mold conditioning sheet comprising at least two base sheets, a mold conditioning component and a molding member, the mold conditioning component and the molding member being enclosed between the two base sheets; characterized in that the base sheets have a structure in which the base sheets include a fibrous base sheet having a porosity of 70% or more as an outermost layer of the mold conditioning sheet, and the molding member is unvulcanized synthetic rubber and/or natural rubber, does not contain a vulcanizing agent and is heat melted during molding of said mold conditioning sheet.

14. A mold conditioning sheet comprising at least two base sheets, a mold conditioning component and a molding member, the mold conditioning component and the molding member being enclosed between the two base sheets; characterized in that the base sheets have a structure in which the base sheets include a fibrous base sheet having a porosity of 70% or more as an upper side layer or an outermost layer of the mold conditioning sheet and a fibrous base sheet having a porosity of 40% or less and/or a heat-resistant film as a lower side layer of the mold conditioning sheet, and the molding member is unvulcanized synthetic rubber and/or natural rubber, does not contain a vulcanizing agent and is heat melted during molding of said mold conditioning sheet.

15. The mold conditioning sheet according to claim 14, which is used to condition a mold die for single-sided encapsulation of a substrate, etc.

16. The mold conditioning sheet according to claim 13, wherein the mold conditioning component mainly comprises a thermosetting resin and a release agent and contains at least one member selected from a mineral powder and a curing agent.

17. The mold conditioning sheet according to claim 13, wherein a combination of the mold conditioning component and the molding member is enclosed by covering or heat sealing a part, or the whole, of the base sheets using a thermoplastic resin film or tape.

18. The mold conditioning sheet according to claim 13, wherein a combination of the mold conditioning component and the molding member is enclosed by adhering the base sheets using at least one of a double-sided tape, an adhesive, and a pressure sensitive adhesive.

19. The mold conditioning sheet according to claim 13, wherein a combination of the mold conditioning component and the molding member is enclosed by adhering the base sheets by pressing or deforming the base sheets.

20. A method of conditioning a mold die comprising the steps of sandwiching a mold conditioning sheet according to claim 13 between two halves of a heated mold die, applying heat and pressure to the mold conditioning sheet for a given time to cure the mold conditioning component, and removing the mold conditioning sheet.

21. The method of conditioning a mold die according to claim 20, which is carried out after the mold die is cleaned.
